(19) United States
(12) Patent Application Publication
(10) Pub. No.: US 2002/0171604 A1
(43) Pub. Date: Nov. 21, 2002

(54) Virtual reality helmet

(76) Inventor: Travis Tadysak, Saint Louis, MO (US)

Correspondence Address: Stephen R. Greiner, Esquire, GREINER LAW OFFICES, P.C., Suite 110, 6701 Democracy Blvd.,, Bethesda, MD, 20817, US

(21) Appl. No.: 09/855,588

(22) Filed: May 16, 2001

(51) Int. Cl. G09G 5/00

(52) U.S. Cl. 345/8

(57) ABSTRACT

A virtual reality helmet including a rigid shell adapted to cover the head of a user. The shell has a front opening to accommodate the face of a user. A pair of straps is secured to the shell across the front opening. A video display unit is positioned between, and suspended from, the straps. A shield is secured to the shell so as to cover the front opening and the video display unit thereby preventing ambient light from entering into the shell through the front opening. A pair of speakers is secured within the shell on opposite sides of the front opening. A cable bundle extends from the helmet so as to connect the video display unit and speakers to a power source and an audio/visual source that may be readily transported by a user in a storage bag having a shoulder harness.

### FIELD OF THE INVENTION

The present invention relates generally to apparatus for image superposition by optical means, e.g., heads-up displays.

### BACKGROUND OF THE INVENTION

Virtual reality systems have been used in a variety of fields to simulate human interaction with an artificial environment. Such systems typically employ a video display unit supported in front of a user's eyes in a goggle-like arrangement. Associated with the display unit are headphones for reproducing sounds in coordination with images generated by the video display unit. By means of the video display unit and headphones, a user's senses of sight and hearing should be fully engaged during use of a virtual reality system. This is not always the case, however.

A number of drawbacks have limited the effectiveness as well as the commercial success of virtual reality systems. First, the imaging ability of many display units has been impaired by ambient light creeping past goggles into a user's eyes. Sound quality has also been hampered by the use of headphones with sound transducers of limited audio range and ineffective insulators from ambient noise. Finally, virtual reality systems have not been particularly durable with the structural mountings and electrical connections of the display units and headphones being weakly made.

### SUMMARY OF THE INVENTION

In light of the problems associated with the known virtual reality systems, it is a principal object of the invention to provide a product, worn in part on the head of a user, which provides a virtual reality experience and which fully isolates the user from ambient light and sound, i.e., his natural environment, for enhanced believability of the virtual reality experience.

It is another object of the invention to provide a product of the type described in the form of a helmet carrying a video display unit and a pair of headphones in a manner that will limit damage thereto if inadvertently dropped or otherwise hit.

It is a further object of the invention to provide a virtual reality helmet which may be adjusted, without need of special tools, to fit heads of varied size.

Still another object of the invention is to provide a virtual reality helmet that is portable and adapted for use with audio and video signal generators. This helmet may be connected to any audio or video sources such as a radio receiver, VCR, DVD player, or compact disc player via a cable bundle constructed to limit tangles. The helmet, therefore, provides a “you are there” experience while watching movies, concerts and sports events. Video games may also be experienced to maximum effect.

It is an object of the invention to provide improved elements and arrangements thereof in a virtual reality helmet for the purposes described which is lightweight in construction, relatively inexpensive to manufacture, and dependable in use.

Briefly, the virtual reality helmet in accordance with this invention achieves the intended objects by featuring a rigid shell for covering the head of a user. The shell has a front opening and a pair of straps secured to the shell across the opening. A video display unit is adjustably suspended from the straps in the opening. A shield is secured to the shell so as to cover the opening and the video display unit thus preventing light from entering into the shell. A pair of speakers is secured within the shell on opposite sides of the opening. A cable bundle extends from the helmet so as to connect the video display unit and speakers to a power source and an audio/visual source.

The foregoing and other objects, features and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a virtual reality helmet tethered to a storage bag in accordance with the present invention.

FIG. 2 is a metallic sheet prior to folding into the preferred shield for the virtual reality helmet.

FIG. 3 is an exploded perspective view of the virtual reality helmet.

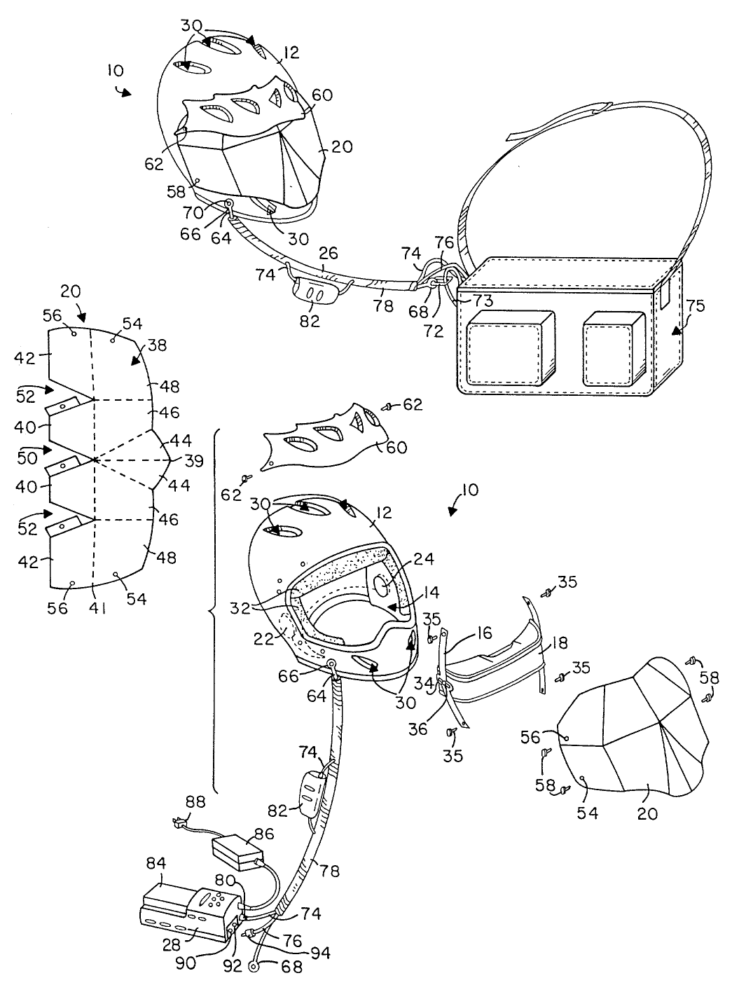

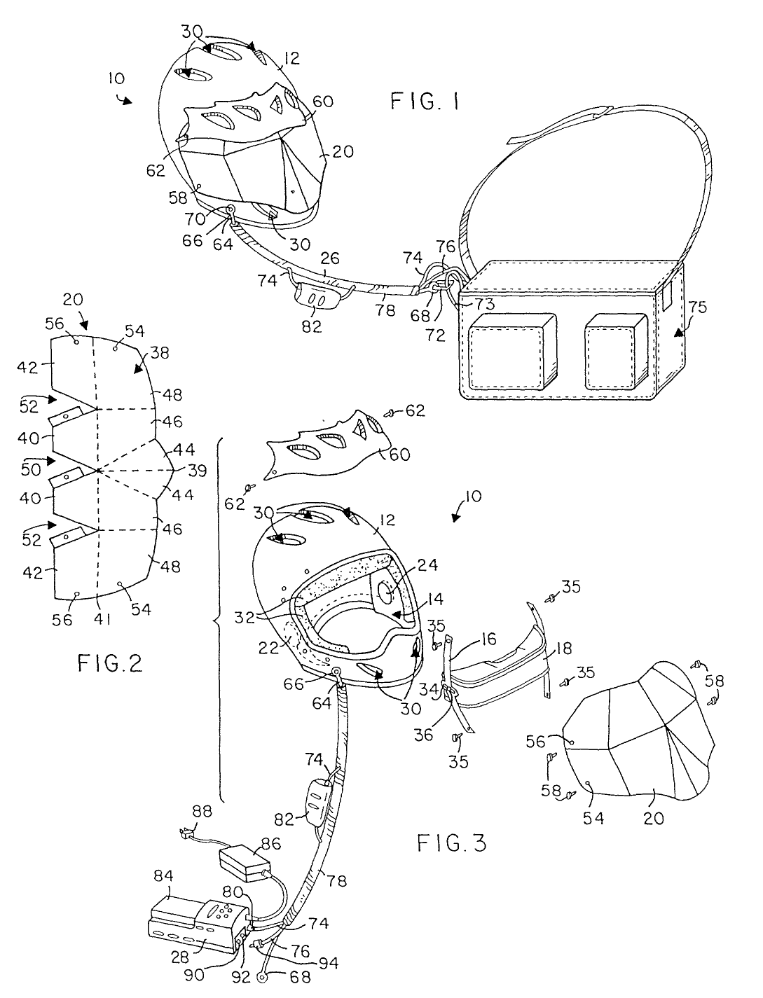

Similar reference characters denote corresponding features consistently throughout the accompanying drawings.

### DETAILED DESCRIPTION OF THE PREFERRED EMBODIMENT

Referring now to the FIGS., a virtual reality helmet in accordance with the present invention is shown at 10. Helmet 10 includes a rigid shell 12 adapted for positioning upon the head of a user. Shell 12 has a front opening 14 with a generally circular outline for accommodating the user's face. Adjustably secured by a pair of straps 16 within opening 14 is a video display unit 18. A shield 20 covers opening 14 and video display unit 18 so as to prevent, ambient light from entering shell 12 and the user's eyes. A pair of speakers 22 and 24 is secured within shell 12 on opposite sides of opening 14. The video display unit 18 and speakers 22 and 24 are, respectively, connected by a cable bundle 26 to power supply box 28 as well as audio and video sources (not shown).

Shell 12 is formed of fiberglass or other suitable material and is preferably configured like a motocross bicycle helmet for dramatic effect. Vents 30 in shell 12 adjacent opening 14 provide the user with air. Foam padding 32 is affixed throughout the interior of shell 12 that makes shell 12 comfortable to wear and isolates speakers 22 and 24 from ambient noise.

Video display unit 18 is preferably of the type found in a Sony PLM 100 personal LCD video monitor but may be of any other kind. Threaded fasteners 34 are run through lateral slots 36 in straps 16 so as to secure straps 16 to opposite sides of video display unit 18. (By selectively untightening fasteners 34, a user may adjust the position of the video display unit 18 relative to his eyes.) Rivets 35 extending through the opposed ends of straps 16 join the straps to shell 12 at points above and below opening 14.

Shield 20 is formed from a single piece of sheet metal 38. A vertical fold line 39 divides sheet metal piece 38 into right and left halves, essentially mirror images of one another, having a plurality of adjoining planar panels 40, 42, 44, 46 and 48. A horizontal fold line 41 divides sheet metal piece 38 into top and bottom portions respectively comprising panels 40 and 42 and panels 44, 46 and 48. Slots 50 and 52 between panels permit sheet metal piece 38 to be bent into a bowl-like shape having a futuristic appearance. Panels 38 and 42 are provided, respectively, with bores 54 and 56 through which threaded fasteners 58 are extended to secure shield 20 to shell 12.

Atop shield 20, a visor 60 is fastened to shell 12 by threaded fasteners 62. Visor 60 projects outwardly from the top of opening 14 and serves to deflect blows that may befall shield 20 during use of helmet 10.

Speakers 22 and 24 are attached by hook and loop fasteners (not shown) to opposite sides of the shell 12 at points where sound will be directed onto a user's ears. Speakers 22 and 24 are of premium quality and are capable of transducing sounds at a frequency range approaching that of the limits of human hearing—20 to 20,000 Hz.

Speakers 22 and 24 and video display unit 18 are connected by cable bundle 26 to audio and video sources. Cable bundle 26 preferably includes a cable 64 of braided wire having loops 66 and 68 at its opposite ends for attachment by means of a threaded fastener 70 to shell 12 and by means of a carabineer 72 to a loop 73 on storage bag 75. Positioned adjacent cable 64 is a cable 74 for energizing video display unit 18 and for delivery of a video signal thereto. Also adjacent cable 64 is a cable 76 for energizing speakers 22 and 24 and for delivering stereo, audio signals thereto. Cables 64, 74 and 76 are joined together by a helical, plastic wrapping 78 along their respective lengths.

Cable 74 includes a plug 80 at its free end for attachment to a power supply box 28. A remote control unit 82 is operatively connected to cable 74 between power supply box 28 and video display unit 18 to permit the operation of the video display unit to be more readily controlled by a user.

The power supply box 28 is adapted to carry a battery pack 84 for powering the video display unit 18 or such may be connected through a transformer 86 and plug 88 to a conventional wall outlet. A socket 90 in power supply box 28 permits connection of said box to any video and audio sources. Through internal circuitry in the power supply box 28, a video signal is delivered to cable 74 for transmission to video display unit 18. The audio signal, on the other hand, is delivered to electrical socket 92 in box 28.

The cable 76 has a plug 94 at its free end for connection to a stereo sound source like socket 92. If desired, however, plug 94 may be connected with another sound source such as a CD player, television or AM/FM radio receiver.

Positioned within storage bag 75 would be power supply box 28, transformer 86, spare battery packs 84, compact discs or DVD discs, a portable CD player, DVD player (not shown) which would serve as an audio/video source for the video display unit 18 and speakers 22 and 24. Bag 75 is preferably internally padded to protect the electronic components positioned inside it.

From the foregoing, it should be appreciated that use of helmet 10 is straightforward. First, the user takes helmet 10 to a comfortable location. (If near a wall outlet, power supply box may be connected to it. Otherwise, power from battery pack 84 will be tapped.) Next, shell 12 is positioned over the head of the user and the location of video display unit 18 on straps 16 is adjusted for comfort. By manipulation of switches on remote control 82, video display unit 18 is switched on and caused to deliver audio and video signals to video display unit 18 and speakers 22 and 24 through cables 74 and 76 respectively. The user may now enjoy an unimpaired, virtual reality experience for as long as he desires or as long as power is available, the user's head being fully isolated from ambient light and sound.

While the invention has been described with a high degree of particularity, it will be appreciated by those skilled in the art that modifications may be made thereto. Therefore, it is to be understood that the present invention is not limited to the sole embodiment described above, but encompasses any and all embodiments within the scope of the following claims.

I claim:

1. A virtual reality helmet, comprising:
a rigid shell adapted to cover the head of a user, said shell having a front opening to accommodate the face of a user;
a strap secured to said shell across said front opening;
a video display unit positioned between, and suspended from, said strap;
a shield secured to said shell so as to cover said front opening and said video display unit thereby preventing ambient light from entering into said shell through said front opening; and,
a pair of speakers secured within said shell on opposite sides of said front opening.

2. The virtual reality helmet according to claim 1 further comprising a cable bundle secured to said rigid shell and extending therefrom, said cable bundle being adapted to connect said video display unit and said speakers to a power source as well as audio and video sources.

3. The virtual reality helmet according to claim 2 wherein said cable bundle includes a wire rope affixed at one end to said shell.

4. The virtual reality helmet according to claim 1 further comprising a protective visor secured to said shell at a location above said front opening.

5. A virtual reality helmet, comprising:
a rigid shell for covering the head of a user, said shell having a circular opening to accommodate the face of a user;
a video display unit adjustably secured within said opening;
a shield secured to said shell so as to cover said opening and said video display unit thereby preventing ambient light from entering into said shell through said opening;
a protective visor secured to said shell at a location above said opening;
a pair of speakers secured within said shell on opposite sides of said opening; and,
a cable bundle secured to said rigid shell and extending therefrom, said cable bundle being adapted to connect said video display unit and said speakers to a power source as well as audio and video sources.

6. The virtual reality helmet according to claim 5 wherein said cable bundle includes a plurality of electrical leads and a wire rope with mechanical fasteners at its ends affixed to said shell.

7. The virtual reality helmet according to claim 6 wherein said cable bundle is fastened to a storage bag within which are disposed a power source, an audio source and video source for energizing said video display unit and said speakers.

8. A virtual reality helmet, comprising:
a rigid shell for covering the head of a user, said shell having a circular opening for accommodating the face of a user;
video display unit adjustably secured within said opening so as to permit movement toward and away from the face of a user;
a shield secured to said shell so as to fully cover said opening and said video display unit;
a pair of speakers secured within said shell on opposite sides of said opening; and,
a cable bundle secured to said shell and extending therefrom, said cable bundle being adapted to connect said video display unit and said speakers to a power supply box.
